(19) United States
(12) Patent Application Publication
(10) Pub. No.: US 2022/0214638 A1
(43) Pub. Date: Jul. 7, 2022

(54) FINISHER WITH MANUAL BINDING/FOLDING STRUCTURE

(71) Applicant: Hewlett-Packard Development Company, L.P., Spring, TX (US)

(72) Inventors: Eiji FUKASAWA, Seongnam-si (KR); Youngbok LEE, Seongnam-si (KR)

(21) Appl. No.: 17/610,197

(22) PCT Filed: Jan. 27, 2020
(86) PCT No.: PCT/US2020/015195

§ 371 Date: Nov. 10, 2021

(30) Foreign Application Priority Data
Oct. 15, 2019 (KR) 10-2019-0128046

(51) Int. Cl. G03G 15/00; B65H 45/18; B65H 31/02; B42B 4/00; B42C 1/12

(52) U.S. Cl. CPC G03G 15/6541; B65H 45/18; B65H 31/02; B42B 4/00; B65H 2801/27; B65H 2402/45; B65H 2407/21; B65H 2601/11; B42C 1/12

(57) ABSTRACT

Provided is a finisher including a post-processor and an online suppliers. The post processor including a binding path, a binding unit to perform any one or combination of processes of a saddle stitching process and a folding process on a sheet-type medium on the binding path, and a manual supply slot to manually be supplied with the sheet-type medium towards the binding path. The online supplier to receive the sheet-type medium from an external device and supply the sheet-type medium to the binding path. A housing accommodating the post-processor and the online supplier and including an online supply slot to receive the sheet-type medium through the online supply slot from the external device.

### BACKGROUND

A finisher is a device for receiving a sheet-type medium (e.g., a print medium) from a printing apparatus (e.g., a copier or a printer) and performing a post-process (e.g., a side stitching process, a saddle stitching process, or a folding process) on the sheet-type medium. The side stitching process refers to a process of aligning a plurality of sheets of a print medium and binding the print medium by inserting staples into a side of the print medium in a length direction. The saddle stitching process refers to a process of aligning a plurality of sheets of a print medium and binding the print medium by inserting staples into a middle portion of the print medium. The saddle stitching process is also called a saddle stitch stapling process. The folding process refers to a process of folding one or more sheets of a print medium one or more times.

In general, the finisher is connected to a printing apparatus to configure an image forming apparatus, and performs a post-process on a print medium on which a printing process is completely performed by the printing apparatus.

### BRIEF DESCRIPTION OF DRAWINGS

FIG. 1 is a schematic view of an example of an image forming apparatus.

FIG. 2 is a perspective view of an example of a finisher.

FIG. 3 is a perspective view showing an example of a structure for exposing a manual supply slot.

FIG. 4 is a perspective view showing a state in which a door is open in the example of the structure for exposing the manual supply slot and illustrated in FIG. 3.

FIG. 5 is a schematic view of an example of a folder.

FIG. 6 shows an example of an offline post-process using the finisher illustrated in FIGS. 1 to 5.

FIG. 7 is a perspective view of a finisher showing an example of a structure for exposing a manual supply slot, and shows a state in which a post-processor is located at an accommodation position.

FIG. 8 shows a state in which the post-processor is located at a taken-out position in the example of the finisher illustrated in FIG. 7.

FIG. 9 is a schematic view of an example of an image forming apparatus.

FIG. 10 is a schematic view of an example of a connection structure between a finisher and a printing apparatus in the example of the image forming apparatus illustrated in FIG. 9.

FIG. 11 is a perspective view of an example of the finisher illustrated in FIG. 9.

FIG. 12 is a perspective view showing a state in which a door is open in the example of the finisher illustrated in FIG. 9.

### DETAILED DESCRIPTION OF EXAMPLES

Hereinafter, examples of a finisher and an image forming apparatus will be described with reference to the attached drawings. In the drawings, like reference numerals denote like elements, and the size or thickness of each element may be exaggerated for clarity of explanation.

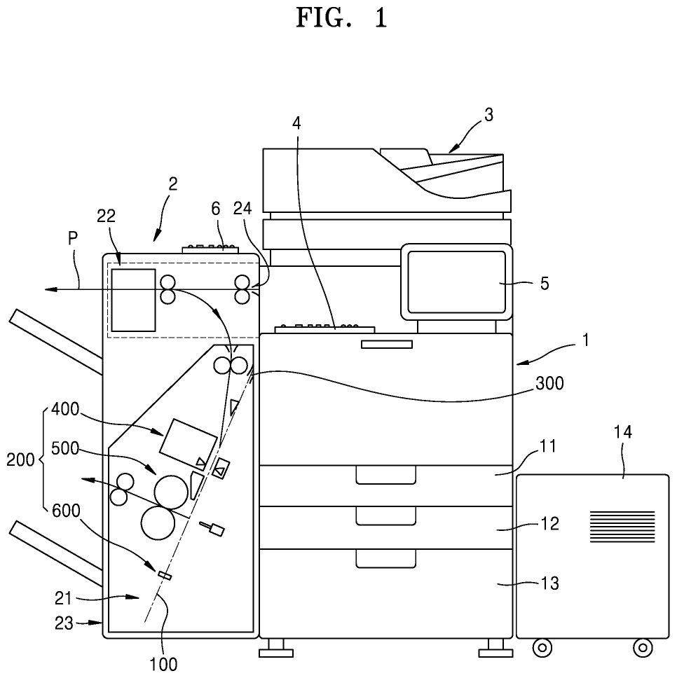

FIG. 1 is a schematic view of an example of an image forming apparatus. Referring to FIG. 1, the image forming apparatus may include a printing apparatus 1 for printing an image on a sheet-type medium, e.g., a print medium P, and a finisher 2 for receiving the print medium P from an external device, e.g., the printing apparatus 1, and performing a post-process on the print medium P.

The printing apparatus 1 prints an image on the print medium P supplied from a feeder. The feeder may include, for example, a main cassette feeder 11 mounted under the printing apparatus 1, a secondary cassette feeder 12 mounted under the main cassette feeder 11, a high capacity feeder 13 mounted under the main cassette feeder 11 or the secondary cassette feeder 12, and a high capacity feeder 14 mounted at a side of the printing apparatus 1. Although not shown in FIG. 1, the feeder may be a multi-purpose tray (MPT).

The printing apparatus 1 may print an image on the print medium P based on various printing methods such as electrophotography, inkjet printing, thermal transfer printing, and thermal sublimation printing. For example, the image forming apparatus of the current example prints a color image on the print medium P based on electrophotography. The above-mentioned printing methods are well known in the art and thus a detailed description thereof is not provided herein.

The image forming apparatus may further include a scanner 3 for reading an image recorded on a sheet-type medium used as a document. The scanner 3 may be of various types, e.g., a flatbed type by which a document is located at a fixed position and a reading member reads an image while moving, a document feed type by which a reading member is located at a fixed position and a document is fed, or a combination thereof. The operating principle and structure of the scanner 3 are well known in the art and thus a detailed description thereof is not provided herein.

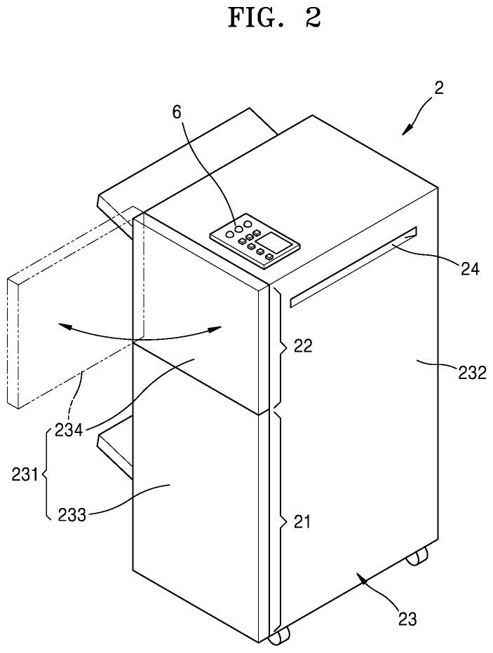

The finisher 2 may be mounted on the printing apparatus 1 as a module of the image forming apparatus. FIG. 2 is a perspective view of an example of the finisher 2. Referring to FIGS. 1 and 2, the finisher 2 may include a post-processor 21, an online supplier 22, and a housing 23.

The post-processor 21 may include a binding path 100, a binding unit 200 for performing at least one of a saddle stitching process and a folding process on the print medium P on the binding path 100, and a manual supply slot 300 for manually being supplied with the print medium P to supply the print medium P towards the binding path 100. The online supplier 22 receives the print medium P from the printing apparatus 1 and supplies the print medium P to the binding path 100. The post-processor 21 and the online supplier 22 are accommodated in the housing 23. The housing 23 includes an online supply slot 24 from which the online supplier 22 receives the print medium P from the printing apparatus 1.

The online supplier 22 may be located on the post-processor 21. The online supplier 22 may discharge the print medium P output from the printing apparatus 1, without performing a post-process. Although not shown in detail in FIGS. 1 and 2, the online supplier 22 may have a structure capable of stapling or punching through a side of the print medium P. The online supplier 22 may discharge the print medium P after stapling or punching through a side of the print medium P output from the printing apparatus 1. The online supplier 22 may supply, to the binding path 100, the print medium P output from the printing apparatus 1.

The binding unit 200 may include at least one of a saddle stitcher 400 for saddle-stitching, e.g., saddle-stitch-stapling, the print medium P on the binding path 100, and a folder 500 for folding the print medium P on the binding path 100 one or more times. The binding unit 200 of the current example includes the saddle stitcher 400 and the folder 500. The binding unit 200 may further include a position aligner 600 for supporting a front side of the print medium P on the binding path 100 and aligning the print medium P at a saddle stitching position and a folding position. The saddle stitching position is a position where a middle portion of the print medium P faces the saddle stitcher 400. The folding position is a position where a portion of the print medium P to be folded faces the folder 500.

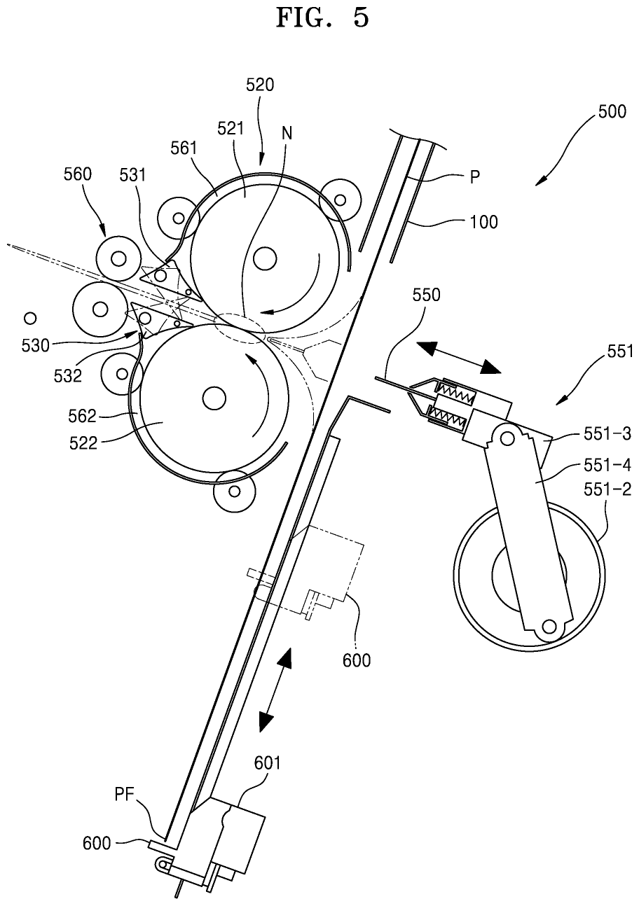

The structure capable of stapling or punching through a side of the print medium P and the structure of the saddle stitcher 400 are well known in the art and thus a detailed description thereof is not provided herein. An example of the folder 500 will be described below with reference to FIG. 5.

Configuration information, e.g., the size of the print medium P, the type of a post-process, and information indicating whether to perform the post-process, may be input through an inputter to the image forming apparatus. The inputter may include, for example, a manipulation panel 4 including a plurality of buttons, and/or a touchscreen 5. When the inputter is implemented by the manipulation panel 4, the manipulation panel 4 may include a display. The manipulation panel 4 and/or the touchscreen 5 may be provided on the printing apparatus 1. An additional manipulation panel 6 may be provided on the finisher 2.

By the above-described configuration, the print medium P discharged from the printing apparatus 1 is supplied through the online supply slot 24 to the finisher 2. The print medium P supplied through the online supply slot 24 to the online supplier 22 may be discharged from the finisher 2 without a post-process, be discharged from the finisher 2 after a process of stapling or punching through a side of the print medium P, or be supplied to the binding path 100 for a saddle stitching process or a folding process.

Referring to FIGS. 1 and 2, as described above, the finisher 2 of the current example includes the manual supply slot 300 capable of manual supply of the print medium P to the binding path 100. The manual supply slot 300 is accommodated in the housing 23. Therefore, when the finisher 2 is attached to the printing apparatus 1 in the form of a module, the manual supply slot 300 is not exposed. To supply the print medium P through the manual supply slot 300 to the binding path 100, the manual supply slot 300 needs to be exposed.

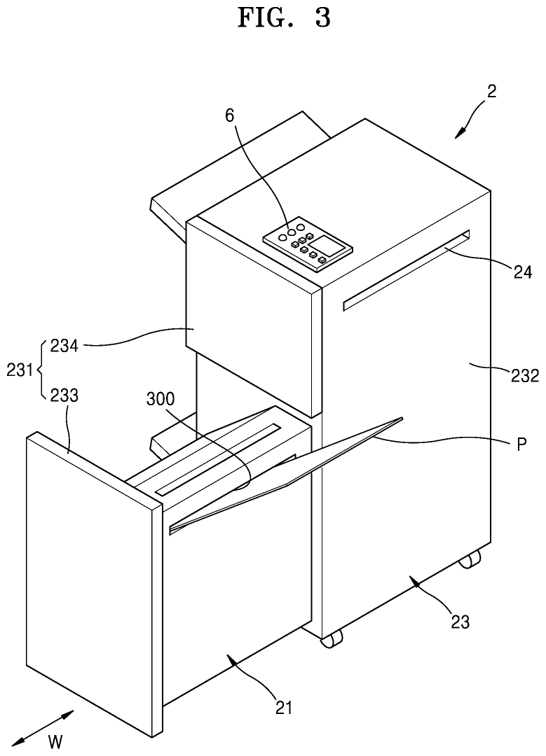

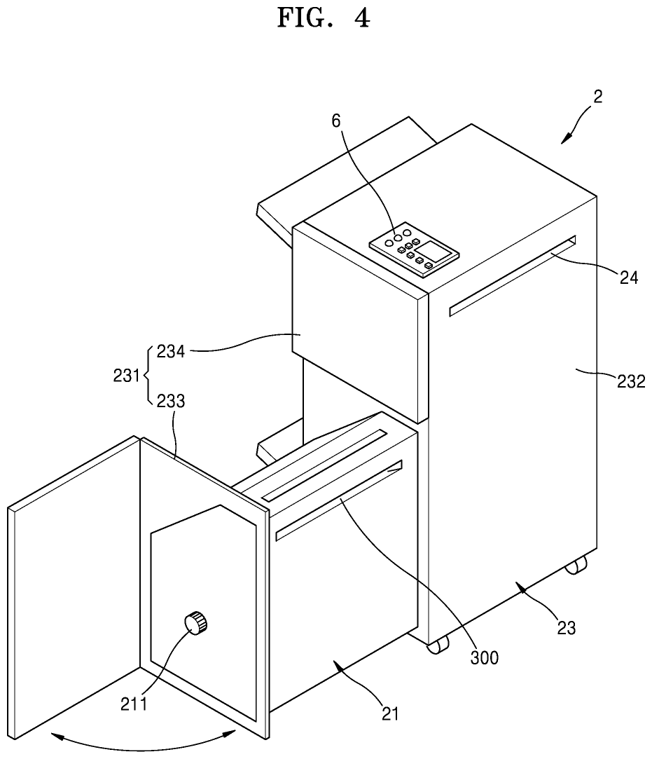

The manual supply slot 300 may be exposed by various structures. FIG. 3 is a perspective view showing an example of a structure for exposing the manual supply slot 300. FIG. 4 is a perspective view showing a state in which a door 233 is open in the example of the structure for exposing the manual supply slot 300 and illustrated in FIG. 3.

Referring to FIGS. 2 and 3, the post-processor 21 is movable between an accommodation position where the post-processor 21 is accommodated in the housing 23 (see FIG. 2), and a manual supply position where the post-processor 21 is taken out of the housing 23 to expose the manual supply slot 300 (see FIG. 3). The housing 23 may include a first side 231 in a width direction W of the print medium P, and a second side 232 facing the printing apparatus 1 and including the online supply slot 24. The post-processor 21 may slide in the width direction W of the print medium P to move between the accommodation position and the manual supply position.

As an example, the housing 23 may include the door 233 moving between the accommodation position and the manual supply position together with the post-processor 21. The door 233 serves as a part of the first side 231 of the housing 23. The door 233 may be attached to a side of the post-processor 21. By the above-described configuration, the post-processor 21 may be moved to the manual supply position by pulling the door 233 in the width direction W and be moved to the accommodation position by pushing the door 233 in the width direction W.

As illustrated in FIG. 4, the door 233 may open or close the side of the post-processor 21 to clear a jam of a print medium, such as a paper jam. For example, the door 233 may be mounted on the side of the post-processor 21 to be rotatable between an open position (see FIG. 4) and a closed position (see FIG. 3). The door 233 may also rotate to the open position when the post-processor 21 is located at the accommodation position. When the door 233 is open, a jam release knob 211 provided on the side of the post-processor 21 may be exposed. The jam release knob 211 may be connected to, for example, folding rollers 520 (see FIG. 5) and discharge rollers 560 (see FIG. 5) to be described below and rotate the folding rollers 520 and the discharge rollers 560. As such, a paper jam that occurred in a folding process may be cleared.

Referring to FIG. 2, the finisher 2 may further include a door 234 for opening or closing a side of the online supplier 22. The door 234 may be connected to the housing 23 to be rotatable between an open position and a closed position. The door 234 may serve as the first side 231 of the housing 23 together with the door 233. When the door 234 is located at the open position, a paper jam that occurred in the online supplier 22 may be cleared through the side of the online supplier 22.

By the above-described configuration, when the post-processor 21 is located at the manual supply position, the manual supply slot 300 may be exposed and the print medium P may be supplied through the manual supply slot 300 to the binding path 100.

FIG. 5 is a schematic view of an example of the folder 500. Referring to FIGS. 1 and 5, the folder 500 may include the folding rollers 520 and a folding blade 550.

The folding rollers 520 are located on the binding path 100. The folding rollers 520 may be located at a downstream side of the saddle stitcher 400 with respect to the binding path 100. The folding rollers 520 include first and second rollers 521 and 522 rotating in contact with each other to form a folding nip N. The first roller 521 is located at an upstream side and the second roller 522 is located at a downstream side with respect to the binding path 100. The folding blade 550 moving between an insertion position for pushing the print medium P on the binding path 100 into the folding nip N (see a dashed line of FIG. 5), and a retreat position retreated from the binding path 100 (see a solid line of FIG. 5) is provided at an entrance of the folding nip N. The folding blade 550 pushes a portion to be folded between a front end and a rear end of the print medium P, into the folding nip N. The folding blade 550 moves between the insertion position and the retreat position by, for example, a folding blade driver 551. The folding blade driver 551 may have various structures. As an example, the folding blade driver 551 may have a slider-crank structure. The folding blade driver 551 may include a rotating member 551-2 being rotatable, a slider 551-3 having the folding blade 550 mounted thereon and being linearly movable, and a crank 551-4 for connecting the rotating member 551-2 to the slider 551-3.

The position aligner 600 supports a front end PF of the print medium P on the binding path 100 and moves between an alignment position for aligning the print medium P (see a dashed line of FIG. 5) and a folding position for aligning a fold position of the print medium P with a position corresponding to the folding nip N (see a solid line of FIG. 5). As described above, the position aligner 600 may move to a binding position for aligning a middle portion of the print medium P with the saddle stitcher 400. The front end PF of the print medium P transported along the binding path 100 is supported by the position aligner 600 located at the alignment position. The position aligner 600 is moved by a lifting member 601 between the alignment position and the folding position. The folding position may include at least an initial fold position of the print medium P. The folding position may further include subsequent fold positions of the print medium P. A position of the position aligner 600 may be detected by a position detection sensor (not shown). The lifting member 601 may include, for example, a linear motor. The lifting member 601 may be implemented by various structures, e.g., a combination of a rotary motor and a linear transport mechanism, or a combination of a rotary motor and a rotary belt or a chain.

By the above-described configuration, the print medium P may be folded once. For example, one or more sheets of the print medium P discharged from the printing apparatus 1 are transported along the binding path 100, and the front end PF thereof is supported by the position aligner 600 located at the alignment position as indicated by a dashed line in FIG. 5. The position aligner 600 moves to the folding position as indicated by a solid line in FIG. 5, to align the fold position of the print medium P with the position corresponding to the folding nip N. Thereafter, the folding blade 550 moves to the insertion position to push the middle portion of the print medium P into the folding nip N. Then, the print medium P is pushed into the folding nip N, is folded once, and comes out from an exit of the folding nip N. The folded print medium P is discharged by the discharge rollers 560. As such, a V-fold is enabled. The fold position may be determined by the position aligner 600.

The folder 500 of the current example may include a guide path for guiding the print medium P having passed through the folding nip N, back to the binding path 100 and returning the print medium P toward the entrance of the folding nip N, and a switching member 530 located at the exit of the folding nip N to selectively guide the print medium P to the discharge rollers 560 or the guide path. The guide path may be provided near at least one of the first and second rollers 521 and 522. In the current example, the guide path includes a first guide path 561 and a second guide path 562 respectively provided near the first and second rollers 521 and 522.

The switching member 530 includes a first switching member 531 for selectively guiding the print medium P to the first guide path 561, and a second switching member 532 for selectively guiding the print medium P to the second guide path 562. Although not shown in FIG. 5, an actuator for driving the first and second switching members 531 and 532 may be provided. The actuator may be, for example, a solenoid actuator. Although not shown in FIG. 5, first and second sensors for detecting the print medium P may be respectively provided on the first and second guide paths 561 and 562. The first and second sensors may provide a reference for determining a second or subsequent fold timing, i.e., a second or subsequent driving timing of the folding blade 550. Driven rollers provided near the first and second rollers 521 and 522 along the first and second guide paths 561 and 562 and not indicated by reference numerals are in contact with the first and second rollers 521 and 522 to transport the print medium P along the first and second guide paths 561 and 562. The print medium P having passed through the folding nip N is wound around the first or second roller 521 or 522 along the first or second guide path 561 or 562 and is returned to toward the entrance of the folding nip N.

As such, the print medium P may be folded twice by returning the print medium P folded once, toward the entrance of the folding nip N along the first or second guide path 561 or 562 and pushing the print medium P into the folding nip N again by using the folding blade 550. A simple 4-fold is enabled by folding a middle portion of the folded print medium P once again. A 3-fold such as a C-fold or a Z-fold is enabled by folding the print medium P twice by using the first or second guide path 561 or 562. A double gate fold, a roll fold, a W-fold, or the like is enabled by folding the print medium P three times by passing the print medium P sequentially through the first and second guide paths 561 and 562.

When a saddle-stitched document is to be scanned or copied, saddle stitches may be removed, each sheet of the document may be scanned using the scanner 3, and image information may be stored in a memory device (not shown) or be transmitted to and printed using the printing apparatus 1. A general finisher not including the manual supply slot 300 may perform only an online post-process for receiving the print medium P supplied from the printing apparatus 1 connected to the finisher, and thus may not saddle-stitch a document by using a binding unit of the finisher. Furthermore, when a document is printed using an image forming apparatus, a user may forget to configure a binding or folding process. In this case, the general finisher not including the manual supply slot 300 may not bind or fold a plurality of sheets of the print medium P discharged from the image forming apparatus without a post-process, and thus the user needs to print the document again through an online post-process after configuring the image forming apparatus to perform a binding or folding process.

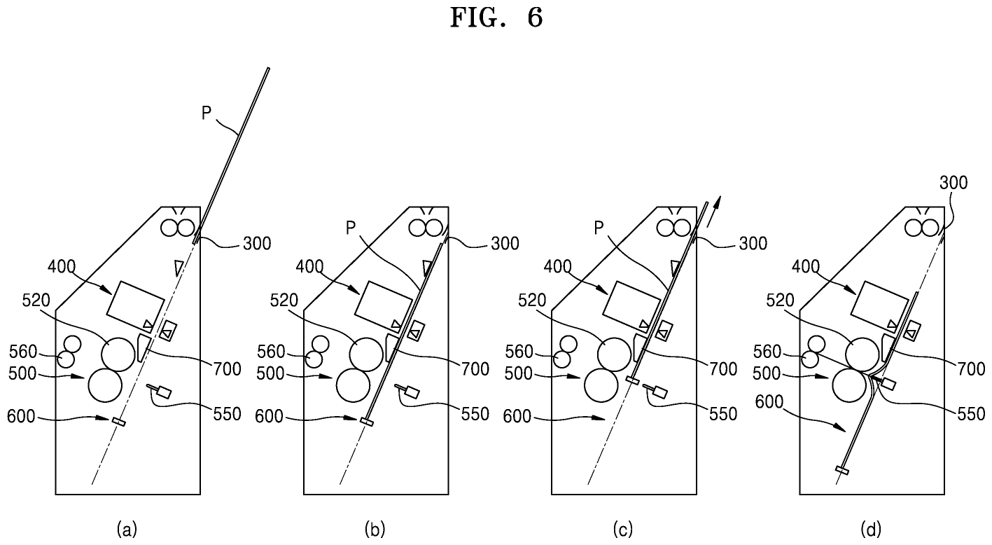

The finisher 2 of the current example illustrated in FIGS. 1 to 5 may perform a saddle stitching process and/or a folding process in an offline mode. FIG. 6 shows an example of an offline post-process using the finisher 2 of the current example. An example of an offline post-process using the finisher 2 will now be described with reference to FIGS. 1 to 6. In FIG. 6, the structure of the post-processor 21 is schematically illustrated. Although the print medium P will be described below as an example of a sheet-type medium to be post-processed, the sheet-type medium to be post-processed may be, for example, a document.

Configuration information of a post-process, e.g., the size of the print medium P, information indicating whether to perform a saddle stitching process, information indicating whether to perform a folding process, and the type of the folding process, is input through the manipulation panel 4 or the touchscreen 5 of the image forming apparatus. Alternatively, the configuration information may be input through the manipulation panel 6 of the finisher 2. The position aligner 600 moves an appropriate receiving position based on the configuration information. For example, the receiving position may be a saddle stitching position. A side fence 700 for aligning the print medium P in the width direction W may be located at an appropriate position based on the configured size information of the print medium P. The inputting of the configuration information may also be performed after the post-processor 21 moves to a manual supply position.

The post-processor 21 is located at the manual supply position by pulling the post-processor 21 in the width direction W of the print medium P as illustrated in FIG. 3. Then, the manual supply slot 300 is exposed. As illustrated in FIG. 6, process (a), the print medium P is manually supplied through the exposed manual supply slot 300 to the binding path 100. A front end of the print medium P is supported by the position aligner 600. Thereafter, a post-process start command is input through the manipulation panel 4 or the touchscreen 5. The post-process start command may be input by, for example, pressing a start button on the manipulation panel 4 or touching a start icon displayed on the touchscreen 5. Alternatively, the post-process start command may be input through the manipulation panel 6 of the finisher 2.

The side fence 700 aligns the print medium P in the width direction W by reciprocating between a position slightly spaced apart from an edge of the print medium P in the width direction W and an alignment position corresponding to the edge of the print medium P in the width direction W. When a saddle stitching process is to be performed, the position aligner 600 moves to the saddle stitching position to align a middle portion of the print medium P in a length direction with the saddle stitcher 400 as illustrated in FIG. 6, process (b). In this state, the saddle stitcher 400 completes the saddle stitching process by inserting staples into the middle portion of the print medium P in the length direction. When a folding process is not to be performed, the position aligner 600 may move from the saddle stitching position toward the manual supply slot 300 to discharge the print medium P through the manual supply slot 300 as illustrated in FIG. 6, process (c). A user may hold the print medium P exposed through the manual supply slot 300 and take the print medium P out of the binding path 100.

When a folding process is to be performed after the saddle stitching process, the position aligner 600 moves to a folding position as illustrated in FIG. 6, process (d). For example, for a V-fold, the folding position may be a position where the middle portion of the print medium P faces the folding nip N (see FIG. 5). In this state, the folding blade 550 moves to an insertion position to push the middle portion of the print medium P into the folding nip N. Then, the print medium P is pushed into the folding nip N, is folded once, and comes out from an exit of the folding nip N. The folded print medium P is discharged by the discharge rollers 560. As such, a V-fold is enabled.

When a folding process is to be performed without performing the saddle stitching process, when the print medium P is supplied through the manual supply slot 300 to the binding path 100 as illustrated in FIG. 6, process (a), the position aligner 600 moves to a folding position as illustrated in FIG. 6, process (d). For example, for a V-fold, the folding position may be a position where the middle portion of the print medium P faces the folding nip N (see FIG. 5). The side fence 700 aligns the print medium P in the width direction W by reciprocating between a position slightly spaced apart from an edge of the print medium P in the width direction W and an alignment position corresponding to the edge of the print medium P in the width direction W. In this state, the folding blade 550 moves to an insertion position to push the middle portion of the print medium P into the folding nip N. Then, the print medium P is pushed into the folding nip N, is folded once, and comes out from an exit of the folding nip N. The folded print medium P is discharged by the discharge rollers 560. As such, a V-fold is enabled.

The folding process may be of various types. The folder 500 may fold the print medium P one or more times based on the configured type of the folding process. For example, the print medium P may be folded twice by returning the print medium P folded once, toward an entrance of the folding nip N along the first or second guide path 561 or 562 (see FIG. 5) and pushing the print medium P into the folding nip N again by using the folding blade 550. A simple 4-fold is enabled by folding a middle portion of the folded print medium P once again. A 3-fold such as a C-fold or a Z-fold is enabled by folding the print medium P twice by using the first or second guide path 561 or 562. A double gate fold, a roll fold, a W-fold, or the like is enabled by folding the print medium P three times by passing the print medium P sequentially through the first and second guide paths 561 and 562.

When the folding process is completed, the print medium P is discharged from the finisher 2 by the discharge rollers 560.

As described above, according to the finisher 2 of the current example, the finisher 2 being capable of performing an offline post-process, a binding or folding process may be performed on a sheet-type medium used as a document, the print medium P output without a post-process, etc. Therefore, separate offline binding equipment is not required and thus installation costs and spaces for office machines may be reduced. In addition, waste of the print medium P due to reprinting for a post-process may be reduced.

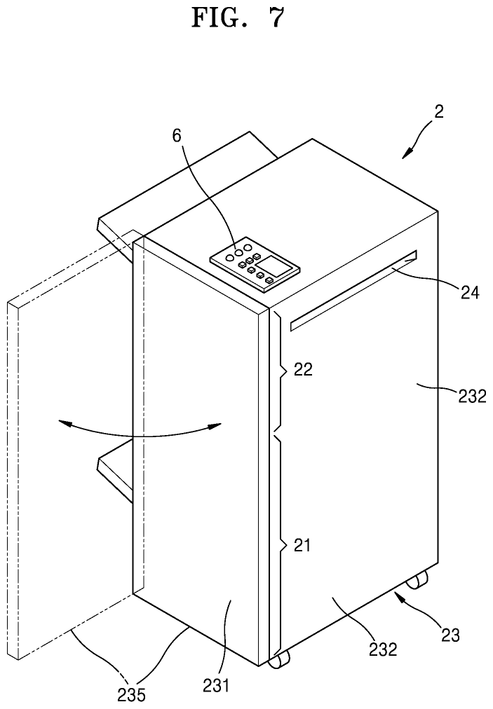

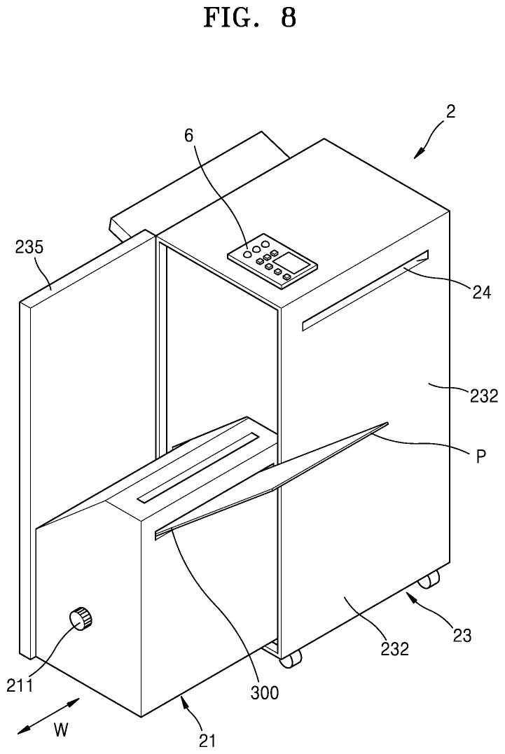

FIGS. 7 and 8 are perspective views of the finisher 2 showing an example of a structure for exposing the manual supply slot 300, and FIG. 7 shows a state in which the post-processor 21 is located at an accommodation position, whereas FIG. 8 shows a state in which the post-processor 21 is located at a manual supply position. Referring to FIGS. 7 and 8, the post-processor 21 is movable between an accommodation position where the post-processor 21 is accommodated in the housing 23 (see FIG. 7) and a manual supply position where the post-processor 21 is taken out of the housing 23 to expose the manual supply slot 300 (see FIG. 8). The housing 23 may include the first side 231 in the width direction W of the print medium P, and the second side 232 facing the printing apparatus 1 and including the online supply slot 24. The housing 23 includes a door 235 for opening or closing the first side 231. The door 235 may rotate between a position for opening the first side 231 and a position for closing the first side 231. The post-processor 21 may slide in the width direction W of the print medium P to move between the accommodation position and the manual supply position.

By the above-described configuration, the post-processor 21 may be moved to the manual supply position by opening the door 235 and pulling the post-processor 21 in the width direction W, and be moved to the accommodation position by pushing the post-processor 21 in the width direction W. When the door 235 is open, the jam release knob 211 provided on a side of the post-processor 21 may be exposed. The jam release knob 211 may be connected to, for example, the folding rollers 520 and the discharge rollers 560 described above and rotate the folding rollers 520 and the discharge rollers 560. As such, a paper jam that occurred in a folding process may be cleared. When the door 235 is located at an open position, a paper jam that occurred in the online supplier 22 may be cleared through a side of the online supplier 22.

By the above-described configuration, when the post-processor 21 is located at the manual supply position, the manual supply slot 300 may be exposed and the print medium P may be supplied through the manual supply slot 300 to the binding path 100. A binding and/or folding process using the finisher 2 illustrated in FIGS. 7 and 8 is the same as that described above in relation to FIG. 6.

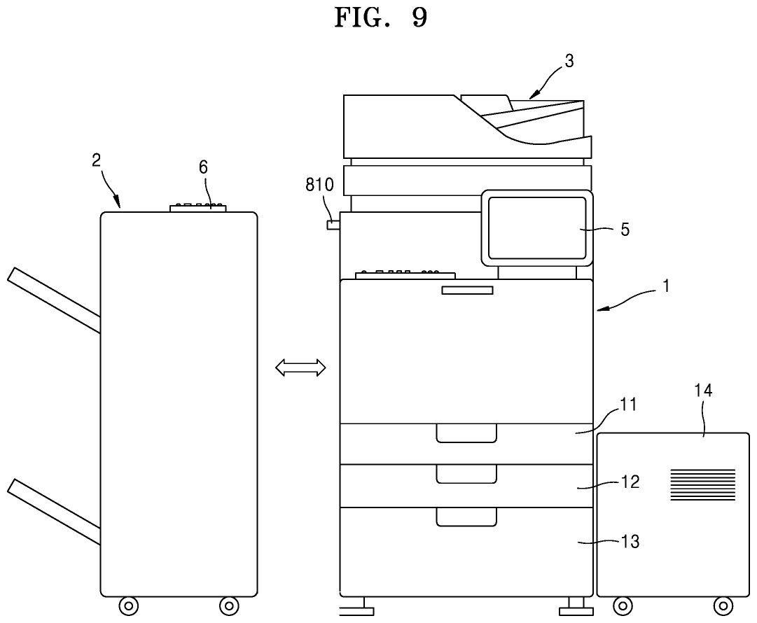

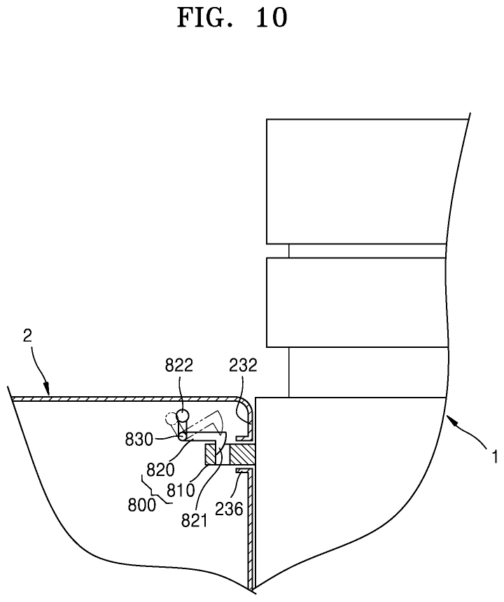

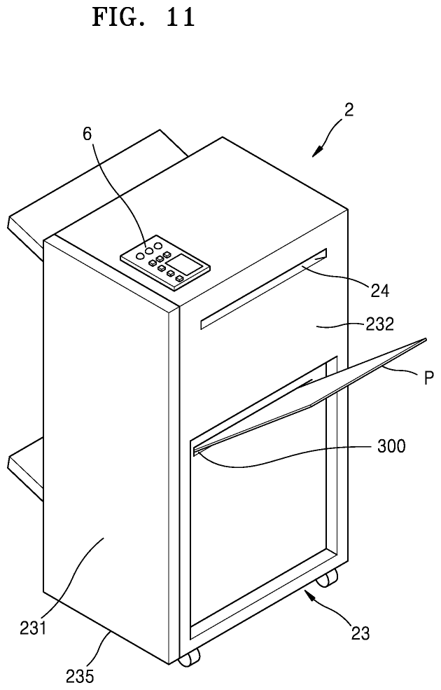

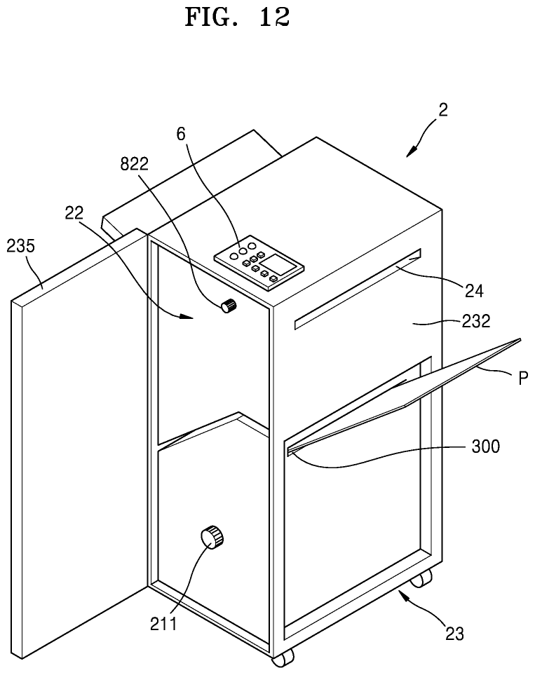

FIG. 9 is a schematic view of an example of an image forming apparatus. FIG. 10 is a schematic view of an example of a connection structure between the finisher 2 and the printing apparatus 1. FIG. 11 is a perspective view of an example of the finisher 2. FIG. 12 is a perspective view of an example of the finisher 2 in a state in which the door 235 is open.

Initially, referring to FIG. 11, the housing 23 may include the first side 231 in the width direction W of the print medium P, and the second side 232 facing the printing apparatus 1 and including the online supply slot 24. The manual supply slot 300 is exposed through the second side 232 of the housing 23. When the finisher 2 is attached to the printing apparatus 1, the manual supply slot 300 is not exposed. To expose the manual supply slot 300, the finisher 2 of the current example is detached from the printing apparatus 1. In this regard, the finisher 2 may be detachably connected to the printing apparatus 1 as illustrated in FIGS. 9 and 10.

Referring to FIG. 10, the finisher 2 is detachably connected to the printing apparatus 1 by a connector 800. The connector 800 may include, for example, an engaging member 810 provided on the printing apparatus 1, and a release member 820 switchable between a connection position where the release member 820 is engaged with the engaging member 810 to connect the finisher 2 to the printing apparatus 1 (see a solid line of FIG. 10), and a disconnection position where the release member 820 is disengaged from the engaging member 810 to disconnect the finisher 2 from the printing apparatus 1 (see a dashed line of FIG. 10). The engaging member 810 may be inserted into the finisher 2 through a insertion hole 236 provided in the second side 232 of the finisher 2. The release member 820 may be provided on the finisher 2 and rotate about a hinge 830 between the connection position and the disconnection position. The release member 820 may include a hook 821 engaged with the engaging member 810, and a lever 822 for switching the release member 820 between the connection position and the disconnection position.

By the above-described configuration, the release member 820 may be switched to the disconnection position to detach the finisher 2 from the printing apparatus 1. When the finisher 2 is detached from the printing apparatus 1, the manual supply slot 300 may be exposed through the second side 232 of the housing 23.

As illustrated in FIGS. 11 and 12, the housing 23 may include the door 235 for opening or closing the first side 231. The door 235 may rotate between a position for opening the first side 231 and a position for closing the first side 231. When the door 235 is open, the jam release knob 211 provided on a side of the post-processor 21 may be exposed. A paper jam that occurred in a folding process may be cleared using the jam release knob 211. When the door 235 is located at an open position, a paper jam that occurred in the online supplier 22 may be cleared through a side of the online supplier 22. In addition, when the door 235 is located at the open position, the lever 822 of the release member 820 may be exposed. Therefore, by opening the door 235, holding the lever 822 and rotating the release member 820 to the disconnection position, the finisher 2 may be detached from the printing apparatus 1 and the manual supply slot 300 may be exposed.

The finisher 2 may include the manipulation panel 6 for configuring an offline post-process. Configuration information, e.g., the size of the print medium P, the type of a post-process, and information indicating whether to perform the post-process, may be input through the manipulation panel 6 to the finisher 2.

By the above-described configuration, the print medium P may be supplied through the manual supply slot 300 to the binding path 100. A binding and/or folding process using the finisher 2 illustrated in FIGS. 9 to 12 is the same as that described above in relation to FIG. 6.

It should be understood that examples described herein should be considered in a descriptive sense only and not for purposes of limitation. Descriptions of features or aspects within each example should typically be considered as available for other similar features or aspects in other examples. While one or more examples have been described with reference to the figures, it will be understood by those of ordinary skill in the art that various changes in form and details may be made therein without departing from the spirit and scope as defined by the following claims.

What is claimed is:

1. A finisher, comprising:
a housing including an online supply slot and to accommodate,
a post-processor including,
a binding path,
a binding unit to perform any one or combination of processes of a saddle stitching process or a folding process on a sheet-type medium on the binding path, and
a manual supply slot to manually be supplied with the sheet-type medium towards the binding path; and
an online supplier to receive the sheet-type medium through the online supply slot from an external device and supply the sheet-type medium to the binding path.

2. The finisher of claim 1, wherein
the post-processor is movable between an accommodation position where the post-processor is accommodated in the housing to receive the sheet-type medium through the online supply slot, and a manual supply position where the post-processor is taken out of the housing to expose the manual supply slot to manually be supplied with the sheet-type medium.

3. The finisher of claim 2, wherein
the post-processor is movable in a width direction of the sheet-type medium with respect to the housing to move between the accommodation position and the manual supply position.

4. The finisher of claim 3, wherein the housing comprises a door moving between the accommodation position and the manual supply position together with the post-processor, and
wherein the door opens or closes a side of the post-processor to enable clearing a jam of the sheet-type medium.

5. The finisher of claim 3, wherein the housing comprises a door to open or close a first side of the housing in the width direction of the sheet-type medium, and
wherein the post-processor is movable to the manual supply position when the door is open.

6. The finisher of claim 1, wherein,
the housing comprises a second side comprising the online supply slot, and
the manual supply slot is exposed through the second side of the housing.

7. The finisher of claim 1, wherein the binding unit comprises:
a saddle stitcher to saddle-stitch the sheet-type medium on the binding path;
a folder to fold the sheet-type medium on the binding path one or more times; and
a position aligner to support a front end of the sheet-type medium on the binding path and align the sheet-type medium at a saddle stitching position and a folding position.

8. An image forming apparatus comprising:
a printing apparatus to print an image on a sheet-type medium; and
a finisher to receive the sheet-type medium from the printing apparatus and perform a post-process on the sheet-type medium,
wherein the finisher includes,
a housing including an online supply slot and to accommodate,
a post-processor including,
a binding path,
a binding unit to perform any one or combination of processes of a saddle stitching process or a folding process on the print medium on the binding path, and
a manual supply slot to manually be supplied with the sheet-type medium towards the binding path; and
an online supplier to receive the sheet-type medium through the online supply slot from the printing apparatus and supply the print medium to the binding path.

9. The image forming apparatus of claim 8, wherein
the post-processor is movable between an accommodation position where the post-processor is accommodated in the housing to receive the sheet-type medium through the online supply slot, and a manual supply position where the post-processor is taken out of the housing to expose the manual supply slot.

10. The image forming apparatus of claim 9, wherein
the post-processor is movable in a width direction of the sheet-type medium with respect to the housing to move between the accommodation position and the manual supply position.

11. The image forming apparatus of claim 10, wherein the housing comprises a door moving between the accommodation position and the manual supply position together with the post-processor, and
wherein the door opens or closes a side of the post-processor to enable clearing a jam of the sheet-type medium.

12. The image forming apparatus of claim 10, wherein the housing comprises a door to open or close a first side of the housing in the width direction of the sheet-type medium, and
wherein the post-processor is movable to the manual supply position when the door is open.

13. The image forming apparatus of claim 8, further comprising a connector to detachably connect the finisher to the printing apparatus,
wherein the housing comprises a second side comprising the online supply slot and facing the printing apparatus, and
wherein the manual supply slot is exposed through the second side of the housing when the finisher is detached from the printing apparatus.

14. The image forming apparatus of claim 13, wherein
the finisher further comprises a manipulation panel to configure an offline post-process.

15. The image forming apparatus of claim 8, wherein the binding unit comprises:
a saddle stitcher to saddle-stitch the sheet-type medium on the binding path;
a folder to fold the sheet-type medium on the binding path one or more times; and
a position aligner to support a front end of the sheet-type medium on the binding path and align the sheet-type medium at a saddle stitching position and a folding position.
